(19) United States
(12) Patent Application Publication
(10) Pub. No.: US 2026/0287702 A1
(43) Pub. Date: Sep. 24, 2026

(54) WEARABLE LOCATOR DEVICE

(71) Applicants: Zoe Calliope Gittel Abovitz, Weston, FL (US); Andres Alberto Lares, Miramar, FL (US)

(72) Inventors: Zoe Calliope Gittel Abovitz, Weston, FL (US); Andres Alberto Lares, Miramar, FL (US)

(21) Appl. No.: 19/575,194

(22) Filed: Mar. 23, 2026

Related U.S. Application Data
(60) Provisional application No. 63/776,176, filed on Mar. 23, 2025.

(51) Int. Cl. G01S 1/04; G01C 21/20; G06F 1/16; G08B 7/02; G08B 7/06; G08B 21/18; G08B 21/22

(52) U.S. Cl. CPC G01S 1/047; G01C 21/20; G01S 1/0423; G01S 1/045; G06F 1/163; G08B 7/02; G08B 7/06; G08B 21/182; G08B 21/22; G01S 2201/04

(57) ABSTRACT

A wearable locator device is provided. A first wearable locator device includes an input device to establish the device as a leader device of a plurality of wearable locator devices. At least one second wearable locator device pairs with the first wearable locator device. Settings are established to trigger generation of a signal to cause the at least one second wearable locator device to generate an output upon detection of the at least one second wearable locator device being at or beyond a threshold distance from the first wearable locator device. If the at least one second wearable locator device is at or beyond the threshold distance, a signal can be provided to the at least one second wearable locator device to cause the at least one second wearable locator device to generate an output to guide the at least one second wearable locator device within the threshold distance.

### CROSS REFERENCE TO RELATED APPLICATIONS

This application is a non-provisional of and claims priority to U.S. Provisional Patent Application No. 63/776,176 filed Mar. 23, 2025, which is herein incorporated by reference in its entirety.

### FIELD OF INVENTION

The present application relates to sensor technologies, location technologies, wearable devices, communication technologies, safety technologies, and, more particularly, to a wearable locator device.

### BACKGROUND

In today's society, people often enjoy participating in various types of activities in various types of environments with others. In certain environments where multiple people in a group are participating in activities with each other, it is often difficult to effectively track and monitor each other's whereabouts to ensure group safety in an efficient and effective manner. For example, hiking environments, water-based environments, camping environments, and other environments with harsh, changing, or challenging conditions can be environments in which people can easily be separated from other members of the group. When a person is separated from a group, particularly in unsafe environments, it can lead to anxiety, injuries, panic, or even death. Currently, some people utilize smart watches or mobile devices, such as smartphones, to assist in tracking people in a group. While such devices can assist in locating people that have been separated from a group, such devices are often significantly more complex to use, may require additional resources, are often more susceptible to breakage, and often cannot withstand the harsher conditions of certain environments. For example, smartphones and smart watches often require complex location systems, messaging systems, and battery power to function as desired. Additionally, such devices often have interfaces that are often difficult to use or navigate, or are more complex than necessary.

Based on at least the foregoing, there remains room for substantial enhancements to existing technologies and processes and for the development of new technologies and processes to facilitate tracking and monitoring of users or even objects within a group. For example, current technologies may be improved and enhanced to track users and facilitate navigation of users back to a group or vice versa more easily and effectively. Such improvements and enhancements to methodologies and technologies may provide for more effective tracking capabilities, reduced panic, fewer injuries, greater navigation efficiencies, among a variety of other benefits.

### SUMMARY

A wearable locator device and systems and accompanying methods for utilizing the wearable locator device are disclosed. In particular, the wearable device, systems, and methods can consistently, effectively, and efficiently track people engaging in activities and facilitate their navigation back to each other. In certain embodiments, each person in a group can have a wearable locator device where at least one of the wearable devices functions as a leader device that each person in the group can pair with using their own wearable locator devices. Various settings can be established to trigger the generation of signals to cause wearable locator devices at or beyond a threshold distance from the leader device to generate outputs to facilitate navigation for the users of such wearable locator devices to navigate back to the leader device. For example, the outputs can include light emitted from light emitting diodes of the wearable locator devices, vibrations from haptic components of the wearable locator devices, sounds emitted by speakers of the wearable locator devices, and/or any other types of outputs, or a combination thereof. Using the outputs, the users wearing the wearable locator device that are at or beyond the threshold distance from the leader device can be guided back to the leader device until they are at a distance less than the threshold distance. For example, once a user that was located outside the threshold distance comes back within the threshold distance, the wearable locator device of the user can be instructed to cease generating the output, such as by the leader device and/or by components of the wearable locator device of the user. Various embodiments of the wearable locator device and systems and methods for utilizing the wearable locator device is disclosed herein.

In certain embodiments, a wearable device is disclosed. The wearable device can include a geolocator device configured to perform a variety of operations. In certain embodiments, for example, the wearable locator device can pair with at least one other wearable device. In certain embodiments, the wearable locator device can establish a threshold distance from the wearable device for triggering transmission of a signal to the at least one other wearable device for guiding the at least one other wearable device. In certain embodiments, upon detection that the at least one other wearable is at or beyond the threshold distance from the wearable device, the wearable device can transmit the signal to the at least one other wearable device to cause the at least one other wearable device to generate an output to facilitate guiding of the at least one other wearable device back within the threshold distance from the wearable device.

In certain embodiments, a system incorporating a plurality of wearable devices is provided. The system, for example, can include a first wearable device and at least one second wearable device. In certain embodiments, the at least one second wearable device can be configured to pair with the first wearable device. In certain embodiments, the at least one second wearable device can be configured to establish a threshold distance from the wearable device for triggering transmission of a signal from the first wearable device to guide the at least second wearable device to the first wearable device. The threshold distance can be established via a setting on the at least one second wearable device, the first wearable device, or a combination thereof. In certain embodiments, the at least one second wearable device can be configured to receive, after detection that the at least second wearable device is at or beyond the threshold distance from the first wearable device, the signal from the first wearable device. In certain embodiments, the at least one second wearable device can be configured to generate, in response to the signal, an output to facilitate guiding of the at least one second wearable device back within the threshold distance from the first wearable device.

In certain embodiments, a method for utilizing a wearable device is provided. In certain embodiments, the method can include pairing a first wearable device with at least one second wearable device. In certain embodiments, the method can include establishing a threshold distance from the first wearable device for triggering transmission of a signal from the first wearable device to guide the at least second wearable device to the first wearable device. In certain embodiments, the method can include receiving, at the at least one second wearable device and after detection that the at least second wearable device is at or beyond the threshold distance from the first wearable device, the signal from the first wearable device. In certain embodiments, the method can include generating, in response to the signal, an output to facilitate guiding of the at least one second wearable device back within the threshold distance from the first wearable device.

These and other features of the wearable locator devices and systems and methods for utilizing wearable locator devices are described in the following detailed description, drawings, and appended claims.

### BRIEF DESCRIPTION OF THE DRAWINGS

FIG. 1 is a schematic diagram of a system incorporating the use of a wearable locator device according to embodiments of the present disclosure.

FIG. 2 illustrates an exemplary wearable locator device featuring an interface incorporating at least one light emitting diode according to embodiments of the present disclosure.

FIG. 3 illustrates the exemplary wearable locator device of FIG. 2 outputting a plurality of light colors to facilitate guiding of a user back to a leader device of a plurality of wearable locator devices according to embodiments of the present disclosure.

FIG. 4 illustrates the exemplary wearable locator device of FIG. 2 outputting a single light color to facilitate guiding of a user back to a leader device of a plurality of wearable locator devices according to embodiments of the present disclosure.

FIG. 5 illustrates an exemplary wearable locator device featuring an interface incorporating an arrangement of light emitting diodes according to embodiments of the present disclosure.

FIG. 6 illustrates the exemplary wearable locator device of FIG. 5 outputting a plurality of light colors to facilitate guiding of a user back to a leader device of a plurality of wearable locator devices according to embodiments of the present disclosure.

FIG. 7 illustrates the exemplary wearable locator device of FIG. 5 outputting a single light color to facilitate guiding of a user back to a leader device of a plurality of wearable locator devices according to embodiments of the present disclosure.

FIG. 8 is an exemplary wearable locator device featuring an interface incorporating a different arrangement of light emitting diodes according to embodiments of the present disclosure.

FIG. 9 illustrates the exemplary wearable locator device of FIG. 8 outputting a plurality of light colors to facilitate guiding of a user back to a leader device of a plurality of wearable locator devices according to embodiments of the present disclosure.

FIG. 10 illustrates the exemplary wearable locator device of FIG. 8 outputting a single light color to facilitate guiding of a user back to a leader device of a plurality of wearable locator devices according to embodiments of the present disclosure.

FIG. 11 illustrates a top view of an exemplary wearable locator device according to embodiments of the present disclosure.

FIG. 12 illustrates a bottom view of an exemplary wearable locator device according to embodiments of the present disclosure.

FIG. 13 illustrates an exemplary wireless charger for charging a wearable locator device according to embodiments of the present disclosure.

FIG. 14 illustrates a side view of an exemplary wearable locator device according to embodiments of the present disclosure.

FIG. 15 illustrates various interface configurations for a wearable locator device according to embodiments of the present disclosure.

FIG. 16 illustrates a side view of another exemplary wearable locator device according to embodiments of the present disclosure.

FIG. 17 is a flow diagram illustrating a sample method for utilizing a wearable locator device according to embodiments of the present disclosure.

FIG. 18 is a schematic diagram of a machine in the form of a computer system within which a set of instructions, when executed, may cause the machine to facilitate use of a wearable locator device or a plurality of wearable locator devices according to embodiments of the present disclosure.

### DETAILED DESCRIPTION OF THE DRAWINGS

A wearable locator device (e.g., wearable locator devices 120, 125, 220, 320, 420, 520, 720, 920) and systems (e.g., system 100) and accompanying methods (e.g., method 1700) for utilizing the wearable locator device are disclosed. In particular, the wearable device, systems, and methods can consistently, effectively, and efficiently track people engaging in activities and facilitate their navigation back to each other. In certain embodiments, each person in a group can have a wearable locator device where at least one of the wearable devices functions as a leader device that each person in the group can pair with using their own wearable locator devices. Various settings can be established to trigger the generation of signals to cause wearable locator devices at or beyond a threshold distance from the leader device to generate outputs to facilitate navigation for the users of such wearable locator devices to navigate back to the leader device. For example, the outputs can include light emitted from light emitting diodes of the wearable locator devices, vibrations from haptic components of the wearable locator devices, sounds emitted by speakers of the wearable locator devices, and/or any other types of outputs, or a combination thereof. Using the outputs, the users wearing the wearable locator device that are at or beyond the threshold distance from the leader device can be guided back to the leader device until they are at a distance less than the threshold distance. For example, once a user that was located outside the threshold distance comes back within the threshold distance, the wearable locator device of the user can be instructed to cease generating the output, such as by the leader device and/or by components of the wearable locator device of the user. Various embodiments of the wearable locator device and systems and methods for utilizing the wearable locator device is disclosed herein. For the purposes of this disclosure, the terms wearable locator device and wearable device can be utilized interchangeably.

In certain embodiments, a wearable device is disclosed. The wearable device can include a geolocator device configured to perform a variety of operations. In certain embodiments, for example, the wearable locator device can pair with at least one other wearable device. In certain embodiments, the wearable locator device can establish a threshold distance from the wearable device for triggering transmission of a signal to the at least one other wearable device for guiding the at least one other wearable device. In certain embodiments, upon detection that the at least one other wearable is at or beyond the threshold distance from the wearable device, the wearable device can transmit the signal to the at least one other wearable device to cause the at least one other wearable device to generate an output to facilitate guiding of the at least one other wearable device back within the threshold distance from the wearable device.

In certain embodiments, the wearable device can include a display interface comprising at least one light emitting diode configured to provide the output in response to the signal. In certain embodiments, the output can include a light pattern emitted by the at least one light emitting diode to guide the at least one other wearable device within the threshold distance from the wearable device. In certain embodiments, the wearable device can include a haptic device configured to provide the output in response to the signal. In certain embodiments, the output can include a pattern of vibrations generated by the haptic device to guide the at least one other wearable device back within the threshold distance from the wearable device. In certain embodiments, the wearable device can include a casing enclosing the geolocator device and can include a band configured to be worn by a user. In certain embodiments, the casing can include a waterproof material including, but not limited to, at least one of silicone, titanium, stainless steel, leather, plastic, latex, water-proof coated materials, ceramic, or carbon fiber.

In certain embodiments, the wearable device can include an input device that can be configured to establish the wearable device as a leader device of a group of wearable devices including the wearable device and the at least one other wearable device based on a first type of interaction with the input device. In certain embodiments, the input device can be configured to initiate pairing with the at least one other wearable device based on a second type of interaction with the input device. In certain embodiments, the input device can be configured to enable a locate mode, activate a display of the wearable device, or a combination thereof, based on a third type of interaction with the input device. In certain embodiments, the input device can be configured to activate or deactivate the wearable device based on a fourth type of interaction with the input device.

In certain embodiments, the wearable device further can include a wireless charging component configured to wirelessly charge a battery of the wearable device when connected to a charger connected to a power source. In certain embodiments, the geolocator device can include a processor, a memory, a location sensor, a communication device, or a combination thereof. In certain embodiments, the wearable device can further include an adjustable bracelet or strap to enable the wearable device to be worn by a user.

In certain embodiments, a system incorporating a plurality of wearable devices is provided. The system, for example, can include a first wearable device and at least one second wearable device. In certain embodiments, the at least one second wearable device can be configured to pair with the first wearable device. In certain embodiments, the at least one second wearable device can be configured to establish a threshold distance from the wearable device for triggering transmission of a signal from the first wearable device to guide the at least second wearable device to the first wearable device. The threshold distance can be established via a setting on the at least one second wearable device, the first wearable device, or a combination thereof. In certain embodiments, the at least one second wearable device can be configured to receive, after detection that the at least second wearable device is at or beyond the threshold distance from the first wearable device, the signal from the first wearable device. In certain embodiments, the at least one second wearable device can be configured to generate, in response to the signal, an output to facilitate guiding of the at least one second wearable device back within the threshold distance from the first wearable device.

In certain embodiments, the output can include display of a plurality of colors of light via at least one light emitting diode in a display interface of the at least one second wearable device. In certain embodiments, a first color of the plurality of colors of light can be lit or outputted on a portion of the display interface to indicate a first direction to guide the at least one second wearable device to the first wearable device. In certain embodiments, at least one second color of the plurality of colors of light can be lit or displayed on a remaining portion of the display to indicate a wrong direction. In certain embodiments, the output can include a pattern of haptic vibrations that adjust in frequency, duration, or a combination thereof, to indicate a direction to guide the at least one second wearable device to the first wearable device. In certain embodiments, the output can include display of a color of light via at least one light emitting diode in a portion of a display interface of the at least one second wearable device to indicate a direction to guide the at least one second wearable device to the first wearable device, and not outputting display of at least one other light emitting diode in a remaining portion of the display interface.

In certain embodiments, the at least one second wearable device can be further configured to transmit a notification to a mobile device in communication with the at least one second wearable device, the first wearable device, or a combination thereof, to indicate that the at least one second wearable device is at or beyond the threshold distance. In certain embodiments, the at least one second wearable device can include a slit in a top surface of a material covering at least one light emitting diode of the at least one second wearable device. In certain embodiments, the output can include light emitted by the at least one light emitting diode to indicate a direction to guide the at least one second wearable device to the first wearable device and can be visible to a user via the slit. In certain embodiments, the at least one second wearable device can be configured to stop the output when the at least one second wearable device is within the threshold distance from the first wearable device.

In certain embodiments, a method for utilizing a wearable device is provided. In certain embodiments, the method can include pairing a first wearable device with at least one second wearable device. In certain embodiments, the method can include establishing a threshold distance from the first wearable device for triggering transmission of a signal from the first wearable device to guide the at least second wearable device to the first wearable device. In certain embodiments, the method can include receiving, at the at least one second wearable device and after detection that the at least second wearable device is at or beyond the threshold distance from the first wearable device, the signal from the first wearable device. In certain embodiments, the method can include generating, in response to the signal, an output to facilitate guiding of the at least one second wearable device back within the threshold distance from the first wearable device. In certain embodiments, the method can include generating the output by outputting light, vibrations, sounds, or a combination thereof, on the at least one second wearable device.

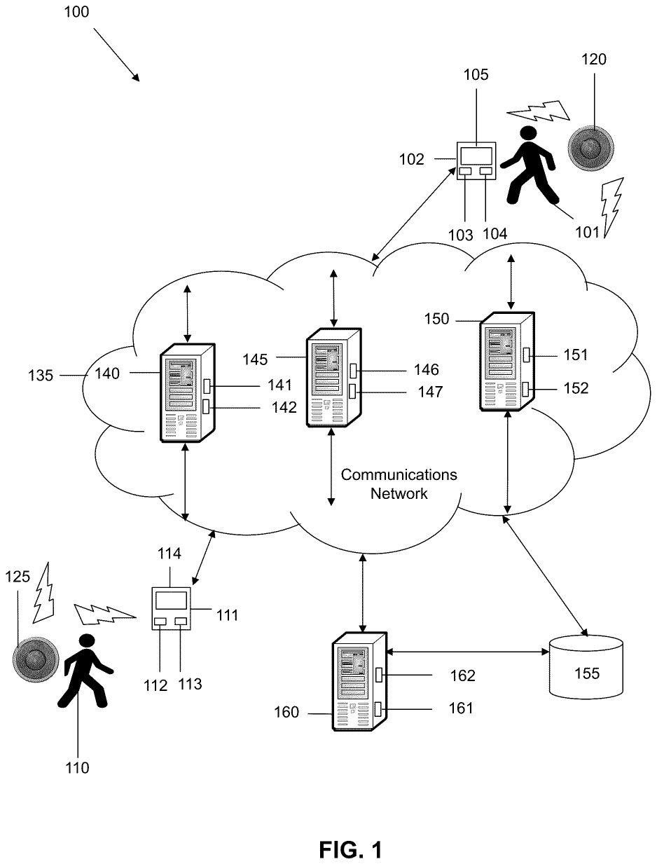

As shown in FIG. 1, a system for incorporating and utilizing wearable locator devices according to embodiments of the present disclosure is disclosed. Notably, the wearable locator devices of the present disclosure can directly connect and communicate with each other and do not require the use of the other components of the system 100. In certain embodiments, however, the wearable locator devices can operate in the system 100. Notably, the system 100 may be configured to support, but is not limited to supporting, location services, tracking services, monitoring services, signaling services, notification services, artificial intelligence services and systems, machine learning services and systems, content delivery services, cloud computing services, satellite services, telephone services, voice-over-internet protocol services (VoIP), software as a service (Saas) applications, platform as a service (PaaS) applications, social media applications and services, mobile applications and services, and/or any other computing applications and services. Notably, the system 100 may include a first user 101, who may utilize a first user device 102 to access data, content, and services, or to perform a variety of other tasks and functions. As an example, the first user 101 may utilize first user device 102 to transmit signals to access various online services and content, such as those available on an internet, on other devices, and/or on various computing systems. As another example, the first user device 102 may be utilized by the first user 101 to access an application, devices, and/or components of the system 100 that provide any or all of the operative functions of the system 100. For example, the first user 101 may utilize the first user device 102 to access an application having a user interface that enables the first user 101 to communicate with a wearable locator device (e.g., wearable locator device 120), transmit signals to control operation of the wearable locator device, receive signals containing instructions and/or information from the wearable locator device, analyze signals and/or information received from the wearable locator device, contact emergency services to assist a user wearing the wearable locator device, gather intelligence associated with the wearable locator device, perform any other operative functionality, or a combination thereof. In certain embodiments, the first user 101 may be a bystander, any type of person, a robot, a humanoid, a program, a computer, any type of user, or a combination thereof, that may be located in a particular environment, such as a home, a body of water, a mountain range, a camping trail, an activity center, a jungle, a forest, a wilderness, a valley, a gorge, a ravine, any other environment, or a combination thereof.

In certain embodiments, the first user 101 may be a person that is participating in an activity with a group of other people including second user 110. For example, the activity could be participating in a water activity in the ocean. The first user 101 may want to be able track each person in the group by utilizing wearable locator devices, such as for safety reasons and to ensure that each person in the group is within a threshold distance of each other and/or a particular user. In certain embodiments, the first user device 102 may be utilized by the first user to interact with the system 100, other users of the system 100, or a combination thereof. In certain embodiments, the first user device 102 may include a memory 103 that includes instructions, and a processor 104 that executes the instructions from the memory 103 to perform the various operations that are performed by the first user device 102. In certain embodiments, the processor 104 may be hardware, software, or a combination thereof. The first user device 102 may also include an interface 105 (e.g., screen, monitor, graphical user interface, etc.) that may enable the first user 101 to interact with various applications executing on the first user device 102 and to interact with the system 100. In certain embodiments, the first user device 102 may be and/or may include a computer, any type of sensor, a laptop, a set-top-box, a tablet device, a phablet, a server, a mobile device, a smartphone, a smart watch, and/or any other type of computing device. Illustratively, the first user device 102 is shown as a smartphone device in FIG. 1. In certain embodiments, the first user device 102 may be utilized by the first user 101 to control and/or provide some or all of the operative functionality of the system 100.

In addition to using first user device 102, the first user 101 may also utilize and/or have access to additional user devices. As with first user device 102, the first user 101 may utilize the additional user devices to transmit signals to access various online services and content and/or to perform the operative functionality of the system 100. The additional user devices may include memories that include instructions, and processors that executes the instructions from the memories to perform the various operations that are performed by the additional user devices. In certain embodiments, the processors of the additional user devices may be hardware, software, or a combination thereof. The additional user devices may also include interfaces that may enable the first user 101 to interact with various applications executing on the additional user devices and to interact with the system 100. In certain embodiments, the first user device 102 and/or the additional user devices may be and/or may include a computer, any type of sensor, a laptop, a set-top-box, a tablet device, a phablet, a server, a mobile device, a smartphone, a smart watch, a camera, and/or any other type of computing device, and/or any combination thereof. Sensors may include, but are not limited to, cameras, motion sensors, acoustic/audio sensors, pressure sensors, temperature sensors, light sensors, heart-rate sensors, blood pressure sensors, sweat detection sensors, eye-tracking sensors, breath-detection sensors, stress-detection sensors, any type of health sensor, humidity sensors, any type of sensors, or a combination thereof.

The first user device 102 and/or additional user devices may belong to and/or form a communications network. In certain embodiments, the communications network may be a local, mesh, or other network that enables and/or facilitates various aspects of the functionality of the system 100. In certain embodiments, the communications network may be formed between the first user device 102 and additional user devices through the use of any type of wireless or other protocol and/or technology. For example, user devices may communicate with one another in the communications network by utilizing any protocol and/or wireless technology, satellite, fiber, or any combination thereof. Notably, the communications network may be configured to communicatively link with and/or communicate with any other network of the system 100 and/or outside the system 100.

In certain embodiments, the first user device 102 and additional user devices belonging to the communications network may share and exchange data with each other via the communications network. For example, the user devices may share information associated with the users of the user devices, information identifying each wearable locator device worn by each person in a group, information identifying the locations of each wearable locator device worn by each person in the group, information identifying user profiles for users of the user devices, information identifying device profiles for the user devices, information identifying the number of devices in the communications network, information identifying devices being added to or removed from the communications network, any other information, or any combination thereof.

The first user 101 can also utilize a wearable locator device 120. In certain embodiments, the wearable locator device 120 can include any of the components and/or functionality as described for wearable locator devices 120, 125, 220, 320, 420, 520, 720, 920. In certain embodiments, for example, the wearable locator device 120 can include a bracelet or strap so that it can be worn by the first user 101, waterproof materials, a geolocator device (e.g., a device configured to determine the geographical location of the wearable locator device 120 being worn by the first user 101 and can include GPS, cellular antennas, communication modules (e.g., Z-wave, Bluetooth, Zigbee, etc.), WiFi modules, any other communication components, or a combination thereof), a processor, a memory, a communication device, any types of sensors, a wireless charging component, an input device (e.g., a button to activate or deactivate the wearable locator device, establish settings for the wearable locator device, activate modes of the wearable locator device, pair the wearable locator device with other wearable locator devices, communicate with other wearable locator devices or devices of the system 100, perform other operations, or a combination thereof), an interface, light emitting diodes, haptic devices and/or components, a charging port, a software application, an emergency transponder, a speaker, a microphone, any other components, or a combination thereof. In certain embodiments, the first user 101 can utilize the first user device 102 to communicate and exchange data with the wearable locator device 120 and vice versa.

In addition to the first user 101, the system 100 may also include a second user 110. In certain embodiments, the second user 110 may also be a user that may be part of the same group with first user 101 and may be participating in the same activity with the first user 101. In certain embodiments, the second user device 111 may be utilized by the second user 110 to transmit signals to request various types of content, services, and data provided by and/or accessible by communications network 135 or any other network in the system 100. In certain embodiments, the second user 110 may utilize the second user device 111 to access an application having a user interface that enables the first user 101 to communicate with a wearable locator device (e.g., wearable locator device 125), transmit signals to control operation of the wearable locator device, receive signals containing instructions and/or information from the wearable locator device, analyze signals and/or information received from the wearable locator device, contact emergency services to assist a user wearing the wearable locator device, gather intelligence associated with the wearable locator device, perform any other operative functionality, or a combination thereof. In certain embodiments, the second user 110 may be a robot, a computer, a vehicle (e.g., semi or fully-automated vehicle), a humanoid, an animal, any type of user, or any combination thereof.

The second user device 111 may include a memory 112 that includes instructions, and a processor 113 that executes the instructions from the memory 112 to perform the various operations that are performed by the second user device 111. In certain embodiments, the processor 113 may be hardware, software, or a combination thereof. The second user device 111 may also include an interface 114 (e.g. screen, monitor, graphical user interface, etc.) that may enable the first user 101 to interact with various applications executing on the second user device 111 and, in certain embodiments, to interact with the system 100. In certain embodiments, the second user device 111 may be a computer, a laptop, a set-top-box, a tablet device, a phablet, a server, a mobile device, a smartphone, a smart watch, and/or any other type of computing device. Illustratively, the second user device 111 is shown as a mobile device in FIG. 1. In certain embodiments, the second user device 111 may also include sensors, such as, but are not limited to, cameras, audio sensors, motion sensors, pressure sensors, temperature sensors, light sensors, heart-rate sensors, blood pressure sensors, sweat detection sensors, breath-detection sensors, eye-tracking sensors, stress-detection sensors, any type of health sensor, humidity sensors, any type of sensors, or a combination thereof.

The second user 110 can also utilize a wearable locator device 125. In certain embodiments, the wearable locator device 125 can include any of the components and/or functionality as described for wearable locator devices 120, 125, 220, 320, 420, 520, 720, 920. In certain embodiments, for example, the wearable locator device 125 can include a bracelet or strap so that it can be worn by the second user 110, waterproof materials, a geolocator device (e.g., a device configured to determine the geographical location of the wearable locator device 125 being worn by the second user 110 and can include GPS, cellular antennas, communication modules (e.g., Z-wave, Bluetooth, Zigbee, etc.), WiFi modules, any other communication components, or a combination thereof), a processor, a memory, a communication device, any types of sensors, a wireless charging component, an input device (e.g., a button to activate or deactivate the wearable locator device, establish settings for the wearable locator device, activate modes of the wearable locator device, pair the wearable locator device with other wearable locator devices, communicate with other wearable locator devices or devices of the system 100, perform other operations, or a combination thereof), an interface, light emitting diodes, haptic devices and/or components, a charging port, a software application, an emergency transponder, a speaker, a microphone, any other components, or a combination thereof. In certain embodiments, the second user 110 can utilize the second user device 111 to communicate and exchange data with the wearable locator device 125 and vice versa.

In certain embodiments, the first user device 102, the wearable locator devices 120, 125, the additional user devices, and/or the second user device 111 may have any number of software applications and/or application services stored and/or accessible thereon. For example, the first user device 102, the wearable locator devices 120, 125, the additional user devices, and/or the second user device 111 may include applications for controlling and/or accessing the operative features and functionality of the system 100, applications for controlling the wearable locator devices 120, 125, cloud-based applications, VoIP applications, other types of phone-based applications, product-ordering applications, business applications, e-commerce applications, media streaming applications, content-based applications, media-editing applications, database applications, gaming applications, internet-based applications, browser applications, mobile applications, service-based applications, productivity applications, video applications, music applications, social media applications, any other type of applications, any types of application services, or a combination thereof. In certain embodiments, the software applications may support the functionality provided by the system 100 and methods described in the present disclosure. In certain embodiments, the software applications and services may include one or more graphical user interfaces so as to enable the first and/or potentially second users 101, 110 to readily interact with the software applications. The software applications and services may also be utilized by the first and/or potentially second users 101, 110 to interact with any device in the system 100, any network in the system 100, or any combination thereof. In certain embodiments, the first user device 102, the wearable locator devices 120, 125, the additional user devices, and/or potentially the second user device 111 may include associated telephone numbers, device identities, or any other identifiers to uniquely identify the first user device 102, the additional user devices, and/or the second user device 111.

The system 100 may also include a communications network 135. The communications network 135 may be under the control of a service provider, any designated user, a computer, another network, or a combination thereof. The communications network 135 of the system 100 may be configured to link each of the devices in the system 100 to one another. For example, the communications network 135 may be utilized by the first user device 102 to connect with other devices within or outside communications network 135. Additionally, the communications network 135 may be configured to transmit, generate, and receive any information and data traversing the system 100. In certain embodiments, the communications network 135 may include any number of servers, databases, or other componentry. The communications network 135 may also include and be connected to a mesh network, a local network, a cloud-computing network, an IMS network, a VoIP network, a security network, a VoLTE network, a wireless network, an Ethernet network, a satellite network, a broadband network, a cellular network, a private network, a cable network, the Internet, an internet protocol network, MPLS network, a content distribution network, any network, or any combination thereof. Illustratively, servers 140, 145, and 150 are shown as being included within communications network 135. In certain embodiments, the communications network 135 may be part of a single autonomous system that is located in a particular geographic region or be part of multiple autonomous systems that span several geographic regions.

Notably, the functionality of the system 100 may be supported and executed by using any combination of the servers 140, 145, 150, and 160. The servers 140, 145, and 150 may reside in communications network 135, however, in certain embodiments, the servers 140, 145, 150 may reside outside communications network 135. The servers 140, 145, and 150 may provide and serve as a server service that performs the various operations and functions provided by the system 100. In certain embodiments, the server 140 may include a memory 141 that includes instructions, and a processor 142 that executes the instructions from the memory 141 to perform various operations that are performed by the server 140. The processor 142 may be hardware, software, or a combination thereof. Similarly, the server 145 may include a memory 146 that includes instructions, and a processor 147 that executes the instructions from the memory 146 to perform the various operations that are performed by the server 145. Furthermore, the server 150 may include a memory 151 that includes instructions, and a processor 152 that executes the instructions from the memory 151 to perform the various operations that are performed by the server 150. In certain embodiments, the servers 140, 145, 150, and 160 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 140, 145, 150 may be communicatively linked to the communications network 135, any network, any device in the system 100, or any combination thereof.

The database 155 of the system 100 may be utilized to store and relay information that traverses the system 100, cache content that traverses the system 100, store data about each of the devices in the system 100 and perform any other typical functions of a database. In certain embodiments, the database 155 may be connected to or reside within the communications network 135, any other network, or a combination thereof. In certain embodiments, the database 155 may serve as a central repository for any information associated with any of the devices and information associated with the system 100. Furthermore, the database 155 may include a processor and memory or may be connected to a processor and memory to perform the various operation associated with the database 155. In certain embodiments, the database 155 may be connected to the servers 140, 145, 150, 160, the first user device 102, the second user device 111, the wearable locator devices 120, 125, 220, 320, 420, 520, 720, 920, the additional user devices, any devices in the system 100, any process of the system 100, any program of the system 100, any other device, any network, or any combination thereof.

The database 155 may also store information and metadata obtained from the system 100, store metadata and other information associated with the first and second users 101, 110, store sensor data and/or media content captured by the first and/or second user devices 102, 111 and/or wearable locator devices 120, 125, 220, 320, 420, 520, 720, 920, store user profiles associated with the first and second users 101, 110, store location data obtained from the wearable locator devices 120, 125, 220, 320, 420, 520, 720, 920, store signals for instructing the wearable locator devices 120, 125, 220, 320, 420, 520, 720, 920 to perform actions, store device profiles associated with any device in the system 100, store signals generated by any of the components of the system 100, store communications traversing the system 100, store user preferences, store information associated with any device or signal in the system 100, store information relating to patterns of usage relating to the user devices 102, 111, store any information obtained from any of the networks in the system 100, store historical data associated with the first and second users 101, 110, store device characteristics, store information relating to any devices associated with the first and second users 101, 110, store information associated with the communications network 135, store markings made by input devices of the system 100, store any information generated and/or processed by the system 100, store any of the information disclosed for any of the operations and functions disclosed for the system 100 herewith, store any information traversing the system 100, or any combination thereof. In certain embodiments, the database 155 can store any number and/or type of machine learning algorithms. Furthermore, the database 155 may be configured to process queries sent to it by any device in the system 100.

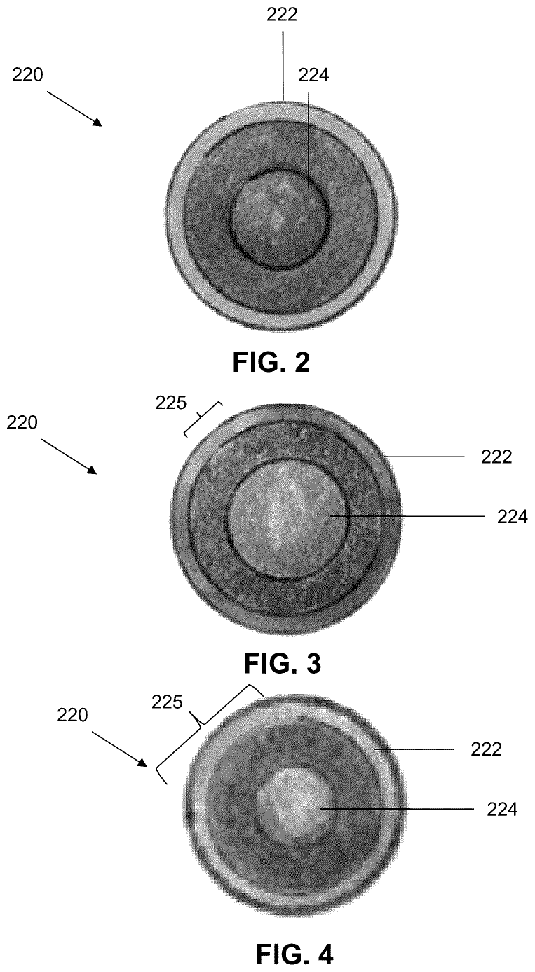

Referring now also to FIGS. 2, 3, and 4, an exemplary wearable locator device 220 is illustrated. The wearable locator device 220 can be utilized to track people engaging in activities and to help them navigate back to each other if they are lost or are beyond a threshold distance from each other. For example, when ocean rescue lifeguards operate a personal watercraft, such as a jet ski with another passenger on the rescue sled, the passenger can be thrown off of the rescue sled without the knowledge of the lifeguard (e.g., if a big wave comes). The lifeguard can have a leader wearable locator device and the passenger and have non-leader wearable locator device, which can alert the thrown off passenger that the passenger is out of range from the lifeguard and can help to navigate the passenger back to the lifeguard and/or vice versa. In certain embodiments, the wearable locator device 220 can include an adjustable band and/or strap made of waterproof material, a geolocator device (e.g., can include GPS, cellular, Zigbee, Z-Wave, WiFi, and/or other communication modules and/or components, and processors, memories, and/or other components), a wireless charging component, a charging port (e.g., for wired charging), an interface 222 for outputting light outputted by one or more light emitting diodes of the wearable locator device 220, any number of light emitting diodes configured to output light (e.g. residing under the interface 222), a user interface to display settings, options, and/or menus, an input device 224 (e.g., button), a power source (e.g., a battery), any number of software applications supporting the functionality of the system 100 (e.g., software applications that can track and store personal health data, set up a profile for the user, set the threshold distance/range from a leader wearable locator device and/or other wearable locator devices, a haptic component and/or system for outputting vibrations having desired patterns and/or intensity, a pairing system, a transponder (e.g., emergency transponder), any other components, or a combination thereof. In certain embodiments, the wearable locator device 220 can be shockproof, waterproof, hazard proof, and/or designed to withstand other types of environmental conditions.

In certain embodiments, the wearable locator device 220 can be configured for use in water-based and/or other outdoor environments. In certain embodiments, the wearable locator device 220 can be configured to be waterproof, shock resistant, hazard resistant, and floatable. For example, the wearable locator device 220 can include a buoyant housing and/or buoyant internal material so that the wearable locator device 220 remains afloat if separated from the user in a body of water, thereby facilitating continued location and retrieval of the wearable locator device 220.

In certain embodiments, the geolocator device and/or communication components of the wearable locator device 220 can be configured to use one or more location and communication technologies, including Bluetooth, GPS, satellite communications, LTE communications, other cellular communications, Wi-Fi communications, Zigbee communications, Z-Wave communications, or a combination thereof. The wearable locator device 220 can communicate directly with one or more other wearable locator devices and/or indirectly through a mobile computing device or other external system.

In certain embodiments, the wearable locator device 220 and/or a mobile computing device executing an application can be configured to perform user setup, create a user profile, establish a threshold distance or range, initiate pairing, activate a locate mode, present notifications, display battery status, store personal health data, monitor one or more other users in a group, or a combination thereof. In certain embodiments, the power source of the wearable locator device 220 can be selected to provide a battery life of approximately 10 to 12 hours, although other battery capacities and operating durations can be utilized.

In certain embodiments, the transponder of the wearable locator device 220 can include an emergency location transponder configured to operate during an emergency condition. In certain embodiments, the emergency location transponder can cooperate with the geolocator device and the communication components of the wearable locator device 220 to provide location information associated with the wearable locator device 220 to another wearable locator device, a mobile computing device, a remote system, or a combination thereof.

In certain embodiments, the wearable locator device 220 can determine whether another wearable locator device is within the threshold distance by obtaining location information from the geolocator device and/or communication components of each wearable locator device and comparing the location information. In certain embodiments, the wearable locator device 220 can determine a separation distance and a direction or bearing to a leader wearable locator device based on GPS data, satellite data, cellular data, Bluetooth data, other communication data, or a combination thereof. In certain embodiments, monitoring and updating of the separation distance and direction can occur continuously, periodically, in response to detected movement, in response to an input by a user, or a combination thereof.

In certain embodiments, the wearable locator device 220 can exchange location information, status information, and/or other data directly with one or more other wearable locator devices and/or indirectly through a mobile computing device, a communications network, a server, or another remote system. In certain embodiments, if communication between paired wearable locator devices is temporarily interrupted, the wearable locator device 220 can store last-known location information and can continue to output guidance and/or alerts based on the last-known location information until updated information is received and communication is reestablished.

In FIG. 2, the wearable locator device 220 can include a ring-shaped interface 222 (or other shape) within which a continuous light emitting diode can output light that is visible through the interface 222 (or display). The input device 224 can be utilized to establish which wearable locator device of a group of wearable locator devices is to serve as the leader wearable locator device (e.g., by pressing on the input device 224 one time), link and/or connect the wearable locator device 220 to the leader wearable locator device (e.g., by pressing the input device two times), enable locate mode (e.g., to locate the wearable locator device and/or provide location data to other wearable locator devices in the group and/or activate the light emitting diode, and activate or deactivate the wearable locator device 220 (e.g., by pressing down on the input device 224 for a period of time until shut off or turn on. In FIG. 3, multicolored light output to guide the user wearing a wearable locator device 222 to a leader device is shown. For example, the portion 225 of the interface 222 can display/output a green light to indicate the direction that the user should move to get to the leader device, such as when the wearable locator device 220 is at or beyond a threshold distance from the leader wearable locator device (or in some embodiments to guide the leader wearable locator device to the wearable locator device to guide the person with the leader wearable locator device to the person that is lost). Other areas of the interface 222 can display/output other colors such as orange (closer to green) and red (farther away from green) indicating the wrong directions to get to the leader device. FIG. 4 illustrates only having the display/output green light in the portion 225 and no light being emitted in the remaining portion of the interface 222. In certain embodiments, the various light patterns can also be utilized to show changes in elevation in an environment (e.g., for activities such as hiking or diving).

In certain embodiments, the interface 222 can output different light patterns to indicate changes in elevation and/or depth in addition to directional guidance toward a leader wearable locator device. For example, a first light pattern can indicate upward movement and a second light pattern can indicate downward movement for activities, such as hiking, climbing, diving, and/or other activities in which elevation or depth changes may be relevant.

In certain embodiments, the interface 222, the haptic component, the speaker, or a combination thereof, can output different output patterns corresponding to different operating conditions of the wearable locator device 220. For example, a first output pattern can indicate that the wearable locator device 220 is within range, a second output pattern can indicate that the wearable locator device 220 is out of range, a third output pattern can indicate a direction toward a leader wearable locator device, a fourth output pattern can indicate an emergency condition, and a fifth output pattern can indicate a low-battery condition and/or a communication-loss condition. In certain embodiments, the output pattern can change in color, intensity, duration, repetition rate, vibration intensity, sound level, or a combination thereof, based on whether the user is moving toward or away from the leader wearable locator device and/or based on an amount by which the threshold distance is exceeded.

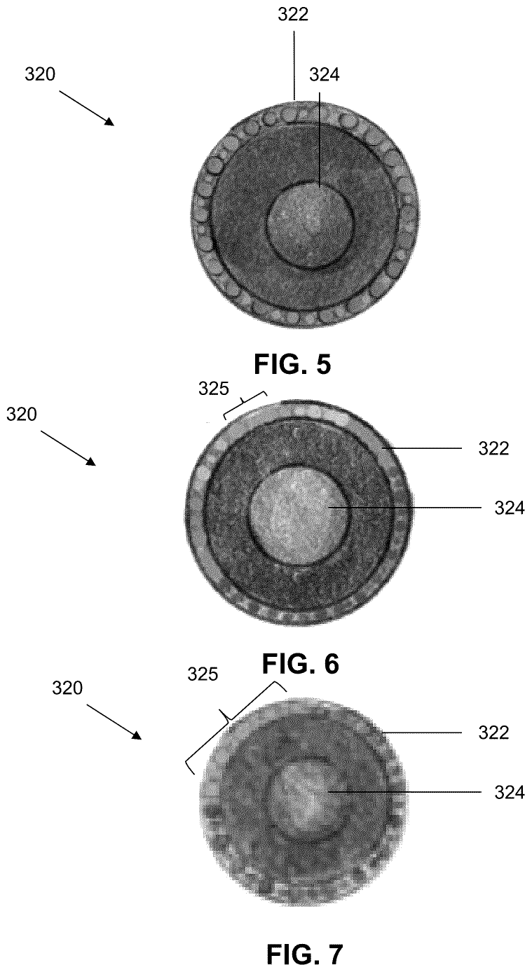

Referring now also to FIGS. 5, 6, and 7, an exemplary wearable locator device 320 is illustrated. The wearable locator device 320 can include any of the components found in wearable locator device 220 (or other wearable locator device described herein), and also include an interface 322 (e.g., display interface) within each light emitting diodes can reside. Additionally, the wearable locator device 320 can also including an input device 324. As depicted in FIGS. 5, 6, and 7, the wearable locator device 320 can have numerous light emitting diodes arranged in a desired pattern, such as in a ring shape and which can be visible via the interface 322. FIG. 5 shows all of the light emitting diodes outputting green light. FIG. 6 shows how the wearable locator device 320 can guide a user back to a leader wearable locator device. For example, the portion 325 of the interface 322 can enable the green light from light emitting diodes to be visible indicating the direction that the user should move towards to get to the leader wearable locator device. Other color lights, such as yellow, orange, and then red can be utilized to indicate the wrong direction with red indicating an opposite direction and yellow and orange showing gradual deviation from the correct direction. FIG. 7 is similar to FIG. 6, but only the portion 325 displays the green light and the remaining portion of the interface 322 does not show any light (e.g., light emitting diodes in such areas are turned off).

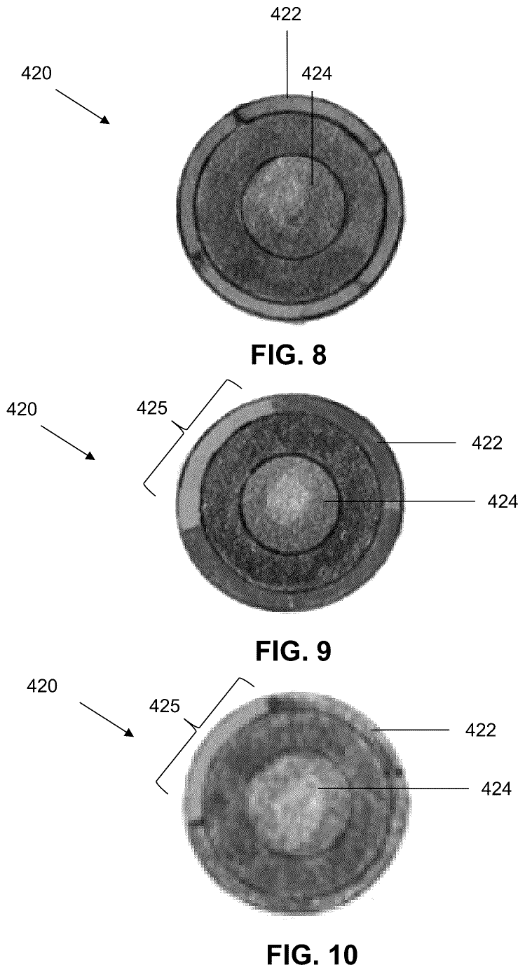

Referring now also to FIGS. 8, 9, and 10, another exemplary wearable locator device 420 is illustrated. The wearable locator device 420 can include any of the components found in wearable locator device 220, 320 (or other wearable locator device described herein), and also include an interface 422 (e.g., display interface) within which four divided displays (e.g., quadrants) including light emitting diodes are provided. Additionally, the wearable locator device 420 can also including an input device 424. As depicted in FIGS. 8, 9, and 10, the wearable locator device 420 can have four separate displays including light emitting diodes arranged in a desired pattern, such as in a ring shape and which can be visible via the interface 422. FIG. 8 shows all of the light emitting diodes outputting green light. FIG. 9 shows how the wearable locator device 420 can guide a user back to a leader wearable locator device. For example, the portion 425 of the interface 422 can enable the green light from light emitting diodes to be visible indicating the direction that the user should move towards to get to the leader wearable locator device. Other color lights, such as red can be utilized to indicate the wrong direction (e.g., in the other 3 displays). FIG. 10 is similar to FIG. 9, but only the portion 425 displays (i.e., one display) the green light and the remaining three displays of the interface 422 does not output any light.

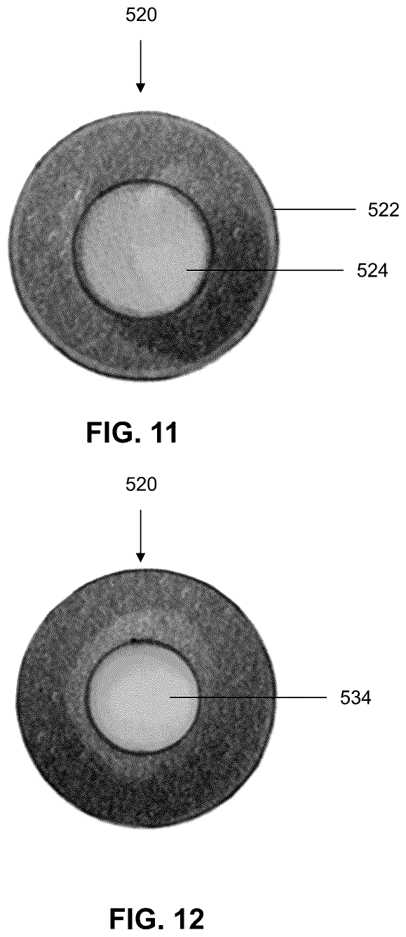

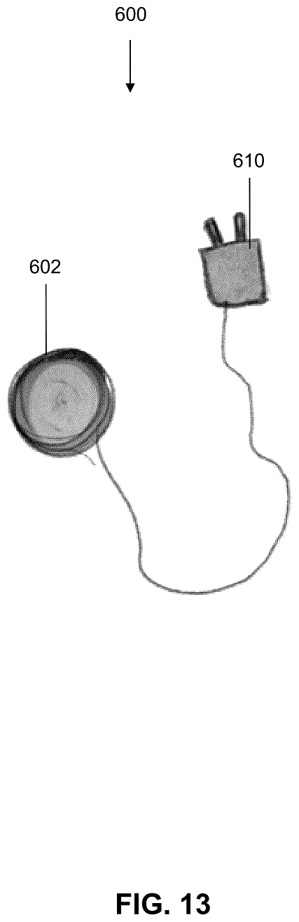

Referring now also to FIGS. 11 and 12, another exemplary wearable locator device 520 is illustrated with FIG. 11 illustrated a top view and FIG. 12 a bottom view. The exemplary wearable locator device 520 can include any of the components of any of the wearable locator devices described in the present disclosure. On the top of the wearable locator device, the wearable locator device 520 can include an interface 522 including a continuous light emitting diode and/or any number of light emitting diodes and an input device 524. On the bottom of the wearable locator device 520 can include a wireless charging component 534 that can connect with (e.g., magnetically) a wireless or other charger to charge a power source (e.g., battery) of the wearable locator device 520. Referring now also to FIG. 13, an exemplary charger 600 for charging a wearable locator device is shown. For example, the charger 600 can include a charger portion 602, which can be magnetic and can connect with the wireless charging component 534 to charge the wearable locator device 520 when the plug 610 is plugged into a socket of a power source. In certain embodiments, the wearable locator device 520 can have a waterproof charging port, which can enable a wired charger to charge the wearable locator device 520 when connected to the charging port.

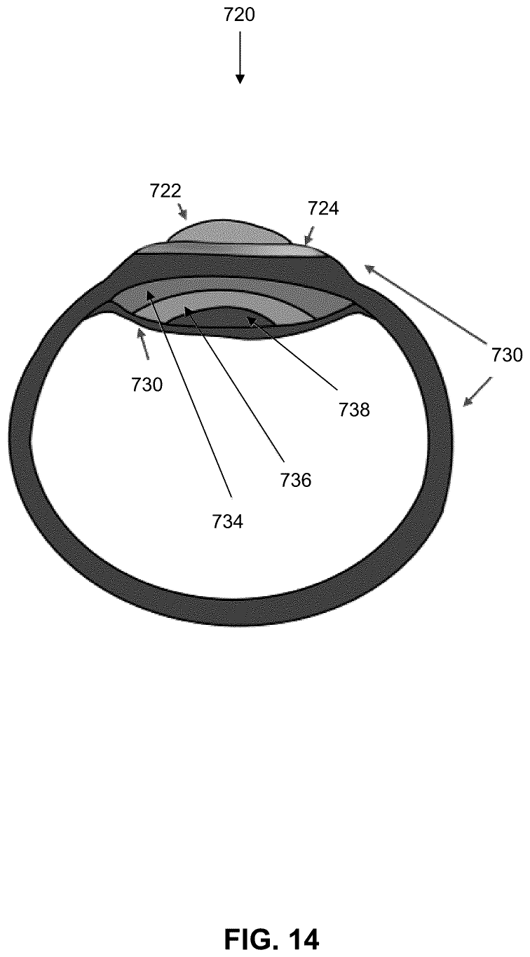

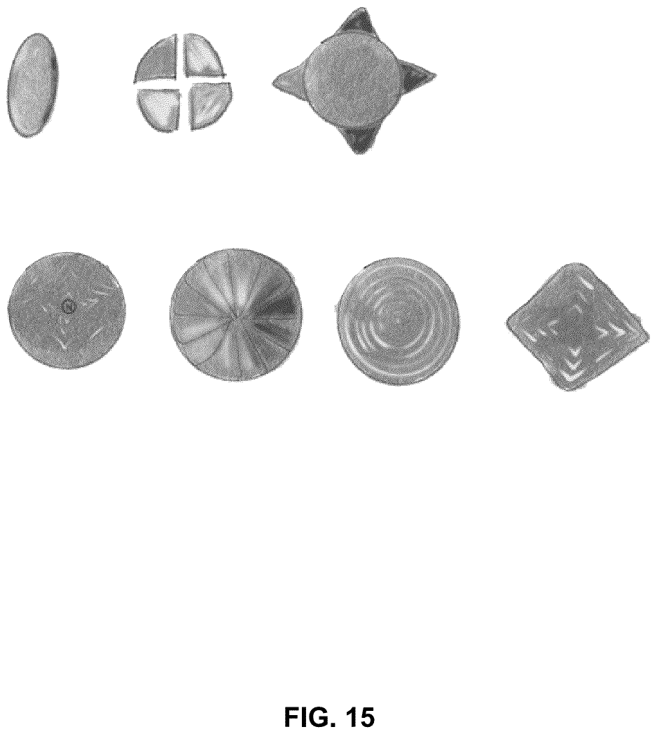

Referring now also to FIG. 14, another exemplary wearable locator device 720 is illustrated. In certain embodiments, the wearable locator device 720 can include an input device 722 (e.g., a button), an interface 724 including light emitting diodes, waterproof material 730 (e.g., bracelet (which can include a clasp) and portion securing the components of the wearable locator device, which can include waterproof materials including, but not limited to, silicone, titanium, stainless steel, leather, plastic, latex, waterproof-coated materials, ceramic, carbon fiber, etc.), a geolocator device 734, a haptic device or system 736 (e.g., for outputting vibrations), a charging component 738, and/or any other components described herein. The wearable locator device 720, for example, can be worn on an arm of a user, such as first user 101 or second user 110. The wearable locator device 720 and/or other wearable locator devices of the present disclosure can be used in any number of use-case scenarios. For example, the wearable locator devices can be used by parents to keep track of children, activity leaders to keep track of patrons, or by groups of people to ensure that they members of the group stay together. Referring now also to FIG. 15, exemplary faces and/or interfaces that can be utilized with a wearable locator device of the present disclosure are shown. Such faces and/or interfaces can be utilized to output different colors, patterns, and/or styles of light to help guide a user back to a leader wearable locator device.

In certain embodiments, the wearable locator devices of the present disclosure can be utilized in a variety of activities and environments in which users may become separated from each other. For example, the wearable locator devices can be utilized during surfing, hiking, skiing, swimming, snowboarding, biking, spearfishing, scuba diving, kite surfing, water-skiing, jet-skiing, walking, running, rafting, mountaineering, boating, sky diving, rock climbing, paddleboarding, hang gliding, paragliding, or other activities. In certain embodiments, the wearable locator devices can be utilized by parents supervising children, activity leaders supervising patrons, groups desiring to remain together, lifeguards, park rangers, excursion operators, or other supervisory users.

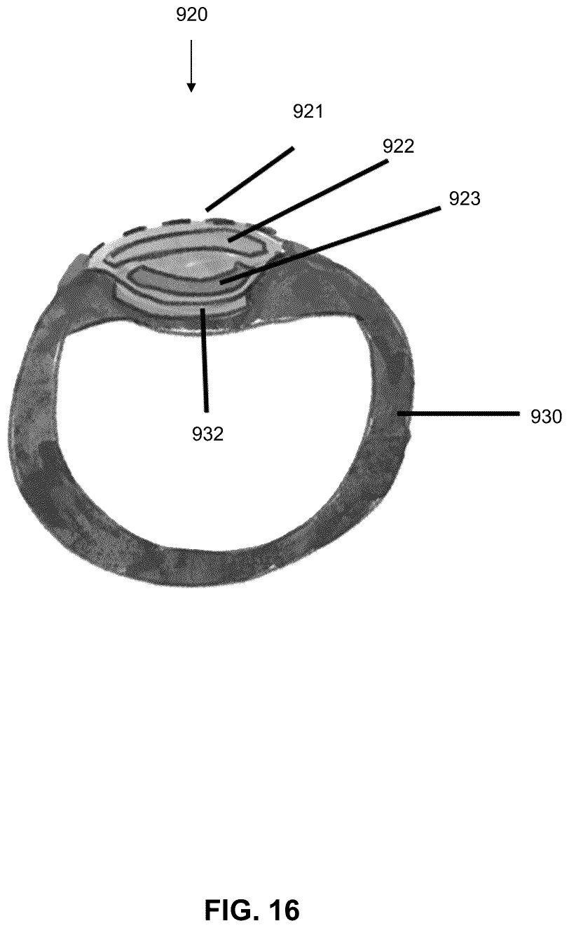

Referring now also to FIG. 16, yet another exemplary wearable locator device 920 is shown. The wearable locator device 920 can include any of the components of any of the other wearable locator devices described in the present disclosure. In certain embodiments, the wearable locator device 920 can include a slit 921 located on a top portion of the face of the wearable locator device 920. The light emitting diode(s) 922 can reside below the slit 921 such that when the light emitting diode(s) 922 is activated, the light is visible through the slit 921. The wearable locator device 920 can also include a battery 923 and a haptic system or component 932. Additionally, the wearable locator device 920 can also include waterproof material 930, which can be incorporated into the bracelet/strap and/or the housing that houses the components of the wearable locator device.

Notably, as shown in FIG. 1, the system 100 may perform any of the operative functions disclosed herein by utilizing the processing capabilities of server 160, the storage capacity of the database 155, or any other component of the system 100 to perform the operative functions disclosed herein. The server 160 may include one or more processors 162 that may be configured to process any of the various functions of the system 100. The processors 162 may be software, hardware, or a combination of hardware and software. Additionally, the server 160 may also include a memory 161, which stores instructions that the processors 162 may execute to perform various operations of the system 100. For example, the server 160 may assist in processing loads handled by the various devices in the system 100, such as, but not limited to, interacting with input devices of the wearable locator devices, pairing wearable locator devices with each other and/or with other devices of the system 100; establishing settings (e.g., settings to trigger generation of signal to cause wearable locator devices to generate outputs); and performing any other operations conducted in the system 100 or otherwise. In certain embodiments, multiple servers 160 may be utilized to process the functions of the system 100. In certain embodiments, the server 160 and other devices in the system 100, may utilize the database 155 for storing data about the devices in the system 100 or any other information that is associated with the system 100. In certain embodiments, multiple databases 155 may be utilized to store data in the system 100.

Although FIGS. 1-18 illustrate specific example configurations of the various components of the system 100, the system 100 may include any configuration of the components, which may include using a greater or lesser number of the components. For example, the system 100 is illustratively shown as including a first user device 102, a second user device 111, a pair of wearable locator devices 120, 125, a communications network 135, a server 140, a server 145, a server 150, a server 160, and a database 155. However, the system 100 may include multiple first user devices 102, multiple second user devices 111, any number of wearable locator devices 120, 125, multiple communications networks 135, multiple servers 140, multiple servers 145, multiple servers 150, multiple servers 160, multiple databases 155, or any number of any of the other components inside or outside the system 100. Furthermore, in certain embodiments, substantial portions of the functionality and operations of the system 100 may be performed by other networks and systems that may be connected to system 100.

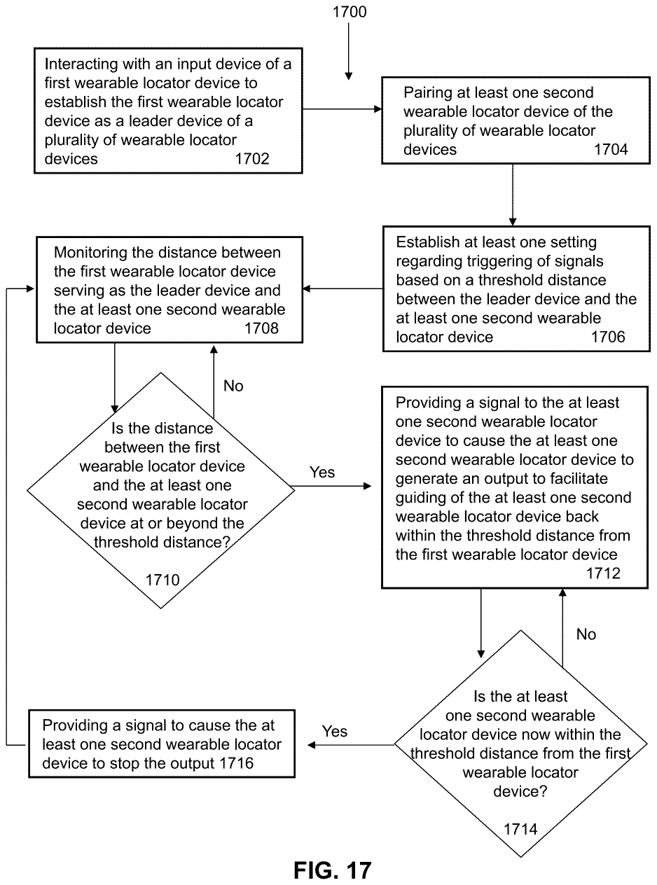

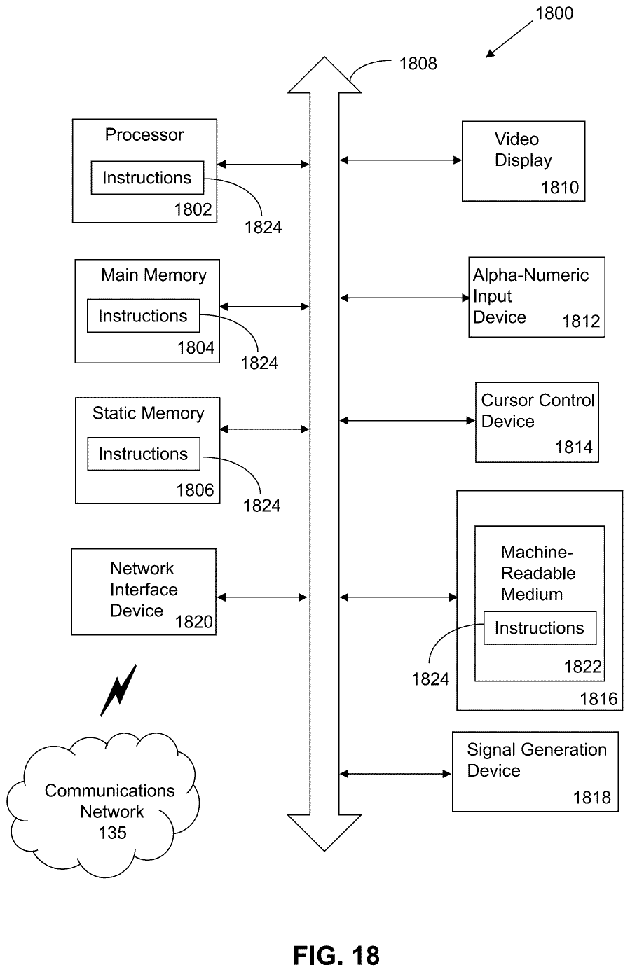

Notably, the system 100 may execute and/or conduct the functionality as described in the method(s) that follow. As shown in FIG. 17, an exemplary method 1700 for utilizing wearable locator devices (e.g., wearable locator devices 120, 125, 220, 320, 420, 520, 720, 920) is schematically illustrated. In certain embodiments, the method of FIG. 17 can be implemented in the system of FIG. 1, the system of FIG. 18, and/or any of the other systems, devices, and/or componentry illustrated in the Figures. In certain embodiments, the method of Figure 1700 may be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 17 may be performed at least in part by one or more processing devices (e.g., processor 104, processor 113, processor 141, processor 146, processor 151, and processor 161 of FIG. 1). In certain embodiments, the method of Figure 1700 can be performed by one or more of the wearable locator devices 120, 125, 220, 320, 420, 520, 720, 920 and/or any of the components shown in the Figures. Although shown in a particular sequence or order, unless otherwise specified, the order of the steps in the method 1700 may be modified and/or changed depending on implementation and objectives. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In certain embodiments, the method 1700 and/or functionality and features supporting the method 1700 may be conducted via an application of the system 100, devices of the system 100 (e.g., first user device 102, wearable locator devices 120, 125, 220, 320, 420, 520, 720, 920, etc.), processes of the system 100, any component of the system 100, or a combination thereof. Generally, the method 1700 may include steps for interacting with input devices of wearable locator devices, pairing wearable locator devices, establishing settings as they relate to the wearable locator devices including interactions between the wearable locator devices and otherwise, monitoring the distance between wearable locator devices, determining whether the distance between the wearable locator devices is at or beyond a threshold distance, providing a signal to each wearable locator devices at or beyond the threshold distance from a leader wearable locator device to cause each wearable locator device to generate outputs to guide the wearable locator devices back within the threshold distance of the leader wearable locator device, determining whether the wearable locator devices are back within the threshold distance of the leader wearable locator device, and providing a signal to cause the wearable devices to stop the output once the wearable locator devices are back within the threshold distance from the leader device.

At step 1702, the method 1700 can include interacting with an input device of a first wearable locator device to establish the first wearable locator device as a leader device of a plurality (or group) of wearable locator devices. For example, the first user 101 can have the wearable locator device 120 established as the leader device (e.g., the leader wearable locator device or first wearable locator device) of a group of wearable locator devices by pressing an input device one time (or other number of times or a pattern of pressings). In certain embodiments, upon pressing the input device one time, the wearable locator device can be set as the leader device. In certain embodiments, upon pressing the input device, a menu can be displayed by an interface on the wearable locator device and/or even the first user device 102 (e.g., based on a signal transmitted from the wearable locator device to the first user device 102 to trigger opening of the menu) to set the wearable locator device 120 as the leader device.

At step 1704, the method 1700 can include pairing each wearable locator device with the leader wearable locator device. For example, the user of each wearable locator device (e.g., second wearable locator devices) that is not the leader wearable locator device can press the input button twice (or use another frequency or pattern of interaction) on the user's corresponding wearable locator device to initiate the pairing with the leader wearable locator device. Similarly, the user of the leader wearable locator device can also press the input device button twice (or use another frequency or pattern of interaction) to enable the pairing between the leader wearable locator device and each other wearable locator device in the group. The pairing can include establishing a communication channel between each of the wearable locator devices so that location data, user data, any other data, or a combination thereof, can be shared between the group of wearable locator devices. In certain embodiments, the pairing can include discovering wearable locator devices (and/or other device) within a range of each wearable locator device, having each wearable locator device verify each other's identity (e.g., authentication using passcodes and/or other authentication mechanisms), and establishing the communication connection between each wearable locator device. In certain embodiments, the pairing can be established by utilizing short-range wireless communication technologies, mid-range wireless communication technologies, and long-range communication technologies. For example, the wearable locator devices can be paired using Bluetooth, Wi-Fi, NFC, Zigbee, Z-Wave, infrared, ultrasonic communication, cellular, and/or other communication technologies.

At step 1706, the method 1700 can include establishing at least one setting relating to the communications, interactions, and/or other aspects of the wearable locators devices in the group. For example, a setting for triggering the generation and transmission of a signal to cause a wearable locator device to generate an output (e.g., a light output, a sound output, a haptic output, any other output, or a combination thereof) can be set to occur when a particular wearable locator device is a specific threshold distance away from the leader wearable locator device. In certain embodiments, each wearable locator device can have the same distance set from the leader wearable locator device, however, in certain embodiments, each wearable locator device can have its own specific threshold distance with respect to the leader wearable locator device (or even other wearable locator devices) to trigger the generation and transmission of the signal. In certain embodiments, other settings can be set as well. For example, each wearable locator device can establish a setting to automatically notify other wearable locator devices and/or user devices when a battery level of the wearable locator device falls below a threshold level, when an acceleration of the wearable locator device is beyond or below a threshold level, when the wearable locator device has not had motion for a threshold period of time, when the wearable locator device exceeds or is below a threshold temperature, when output mechanisms of a wearable locator device fail or are faulty (e.g., light emitting diodes stop work or are intermittently working or haptic components stop working, etc.), when a pressure exerted against the wearable locator device exceeds a threshold level, when a humidity of the wearable locator device exceeds a threshold level, when ambient light level in a vicinity of a wearable locator device is below a threshold level, when any other condition occurs, or a combination thereof.

In certain embodiments, a leader wearable locator device and/or an application executed by a mobile computing device can present group-management information for a plurality of paired wearable locator devices. For example, the group-management information can identify which wearable locator devices are paired in a group, which wearable locator devices are within range or out of range, battery status of each wearable locator device, threshold distance settings associated with each wearable locator device, and whether a locate mode and/or lost mode is active for a particular wearable locator device. In certain embodiments, the application and/or leader wearable locator device can be utilized to add or remove wearable locator devices from the group and to assign different threshold distance settings to different wearable locator devices.

In certain embodiments, one or more settings of the wearable locator devices can be selected based on an activity type, an environment type, a user type, or a combination thereof. For example, the threshold distance, output pattern, notification type, monitoring interval, emergency trigger condition, or a combination thereof, can be selected differently for a water-based activity, a hiking activity, a diving activity, a skiing activity, an excursion activity, or another activity. In certain embodiments, different wearable locator devices in a same group can utilize different settings based on the corresponding users, activities, and/or environments.

In certain embodiments, an emergency mode can be initiated manually via the input device 224 and/or a mobile computing device and/or automatically in response to one or more detected conditions. The one or more detected conditions can include, for example, a wearable locator device remaining out of range for at least a threshold period of time, a battery level falling below a threshold level, acceleration exceeding a threshold level, lack of detected motion for a threshold period of time, or another condition detected by one or more components of the wearable locator device. In certain embodiments, when the emergency mode is initiated, the wearable locator device can cause transmission of device identity information, user information, last-known location information, movement information, battery-status information, or a combination thereof, to a leader wearable locator device, a mobile computing device, a vehicle or watercraft interface, a remote system, or a combination thereof.

Once the setting(s) are established, the method 1700 can proceed to step 1708, which can include monitoring the distance between the leader wearable locator device (e.g., the first wearable locator device) and each of the other wearable locator devices (e.g., second wearable locator devices). At step 1710, the method 1700 can include determining if the distance between the leader wearable locator device each other wearable locator devices is at or beyond the threshold distance established in the settings. If the distance between the leader wearable locator device and a particular other wearable locator device is below the threshold, the method 1700 can continue with step 1708 and monitor the distance between the devices. If, however, the distance between the leader wearable locator device and at least one other wearable locator device in the group is at or beyond the threshold distance, the method 1700 can proceed to step 1712.

At step 1712, the method 1700 can include generating and providing a signal to each wearable locator device (e.g., each a second wearable device) at or beyond the threshold distance to cause each wearable locator device to generate an output to facilitate guiding of each wearable locator device back within the threshold distance from the leader wearable locator device (e.g., the first wearable locator device). In certain embodiments, for example, the output that is generated can be light emitted by one or more light emitting diodes of each wearable locator device, vibrations output by haptic components of each wearable device, sounds or spoken directions outputted by speakers of each wearable locator device, any other type of output, or a combination thereof. In certain embodiments, the output can be outputted in such a way to guide each user wearing a wearable locator device beyond the threshold distance back to the leader wearable locator device (or even other wearable locator devices if set up to do so). For example, on an interface of a wearable locator device, a green light can be output on a specific portion of the interface that effectively points the user in the correct direction to travel and orange or red lights can be outputted on remaining portions of the interface that indicate the wrong direction to travel in. As another example, for the haptic components, vibrations can increase in intensity and/or frequency when a user is moving the correct direction towards the leader wearable locator device and reduce in intensity and/or frequency when the user is moving in the wrong direction. As another example, a speaker can output sounds that increase in intensity and/or frequency when the user is moving in the correct direction and/or decrease in intensity and/or frequency when the user is moving in the wrong direction. As another example, in certain embodiments, the speaker can output spoken directions that can tell and/or guide the user as to the correct direction to move with respect to the leader wearable locator device.

In certain embodiments, when one or more wearable locator devices are at or beyond respective threshold distances from a leader wearable locator device, the leader wearable locator device, a mobile computing device, or a combination thereof, can also generate an alert identifying the particular wearable locator device that is out of range. In certain embodiments, the alert can include a visual output, a haptic output, an audible output, a notification output, or a combination thereof, and can identify a device identity, a user identity, last-known location information, relative direction information, status information, or a combination thereof. In certain embodiments, the system can be configured to guide the out-of-range wearable locator device toward the leader wearable locator device, to guide the leader wearable locator device toward the out-of-range wearable locator device, or to guide both wearable locator devices toward each other.

At step 1714, the method 1700 can include determining whether each wearable locator device is now within the threshold distance of the leader wearable locator device. For each wearable locator device that is still at or beyond the threshold distance from the leader wearable locator device, the method 1700 can continue outputting the outputs to guide the users back to the leader wearable locator device. For each wearable locator device that is now within the threshold distance from the leader wearable locator device, the method 1700 can proceed to step 1716. At step 1716, the method 1700 can include providing a signal to cause each wearable locator device within the threshold distance from the leader wearable locator device to stop the output. Notably, the method 1700 may further incorporate any of the features and functionality described for the system 100, any other method disclosed herein, or as otherwise described herein. Moreover, any of the functionality of the method 1700 can be performed using devices and/or applications configured to perform the functionality of the method 1700, or a combination thereof.

In certain embodiments, wearable locator devices of the present disclosure can include additional features and functionality. For example, when a wearable locator device is out of range of a leader wearable locator device, the display of the out-of-range wearable locator device can remain illuminated until the wearable locator device is back in range and/or until the leader wearable locator device deactivates a LOST mode. In certain embodiments, wearable locator devices can be distributed for use at beaches, parks, visitor centers, guided excursions, activity centers, or other supervised environments to indicate when a person has moved beyond an acceptable predetermined range and to assist in locating the person. In such embodiments, the leader wearable locator device can be associated with a lifeguard, park ranger, guide, operator, or other supervisory user. In certain embodiments, the wearable locator devices can be incorporated into and/or installed in vehicles, personal watercraft, boats, or other objects and can be utilized to indicate when the vehicle, watercraft, or object is out of range of a particular leader device and/or when a person has moved out of range relative to the vehicle, watercraft, or object. An alert can be displayed on an interface of the vehicle, watercraft, or object. In certain embodiments, the wearable locator device can be secured to an arm or other body part of a user using a removable device band, a magnetic clasp, a clasp with a covering latch, or another securing mechanism.

In certain embodiments, a locate mode and/or a LOST mode can cause a wearable locator device to increase transmission of location information and/or status information and to generate a more prominent output to facilitate locating a user or device. For example, the wearable locator device can output a brighter or different light pattern, a stronger vibration pattern, a louder sound output, or a combination thereof, during the locate mode and/or the LOST mode. In certain embodiments, the locate mode and/or the LOST mode can remain active until the wearable locator device is back within range, until the mode is deactivated by a leader wearable locator device, until the mode is deactivated by a mobile computing device, or a combination thereof.

In certain embodiments, when the wearable locator devices are incorporated into and/or installed in a vehicle, personal watercraft, boat, or other object, the interface associated with the vehicle, personal watercraft, boat, or other object can identify a particular wearable locator device that is out of range and can present an alert and/or directional information associated with the out-of-range wearable locator device. For example, in a rescue scenario involving a personal watercraft and a passenger, the interface can indicate that the passenger-associated wearable locator device has moved beyond the threshold distance and can provide guidance to assist in navigating the personal watercraft toward the out-of-range wearable locator device.

The systems and methods disclosed herein may include still further functionality and features. For example, the operative functions of the system 100 and method may be configured to execute on a special-purpose processor specifically configured to carry out the operations provided by the system 100 and method. Notably, the operative features and functionality provided by the system 100 and method may increase the efficiency of computing devices that are being utilized to facilitate the functionality provided by the system 100 and the various methods discloses herein. For example, by training the system 100 over time based on data and/or other information provided and/or generated in the system 100, a reduced amount of computer operations may need to be performed by the devices in the system 100 using the processors and memories of the system 100 than compared to traditional methodologies. In such a context, less processing power needs to be utilized because the processors and memories do not need to be dedicated for processing. As a result, there are substantial savings in the usage of computer resources by utilizing the software, techniques, and algorithms provided in the present disclosure. In certain embodiments, various operative functionality of the system 100 may be configured to execute on one or more graphics processors and/or application specific integrated processors.

Notably, in certain embodiments, various functions and features of the system 100 and methods may operate without any human intervention and may be conducted entirely by computing devices, robotic devices, other devices, or a combination thereof. In certain embodiments, for example, numerous computing devices may interact with devices of the system 100 to provide the functionality supported by the system 100. Additionally, in certain embodiments, the computing devices of the system 100 may operate continuously and without human intervention to reduce the possibility of errors being introduced into the system 100. In certain embodiments, the system 100 and methods may also provide effective computing resource management by utilizing the features and functions described in the present disclosure. For example, in certain embodiments, devices in the system 100 may transmit signals indicating that only a specific quantity of computer processor resources (e.g. processor clock cycles, processor speed, etc.) may be devoted to signaling the wearable locator devices 120, generating outputs in response to signaling (e.g., the amount of intensity of light from the light emitting diodes and/or duration of display of light), generating location data (e.g., via the geolocator device of a wearable locator device), and/or performing any other operation conducted by the system 100, or any combination thereof. For example, the signal may indicate a number of processor cycles of a processor may be utilized to specify a selected amount of processing power that may be dedicated to generating or any of the operations performed by the system 100. In certain embodiments, a signal indicating the specific amount of computer processor resources or computer memory resources to be utilized for performing an operation of the system 100 may be transmitted from the first and/or second user devices 102, 111 and/or the wearable locator devices 120, 125, 220, 320, 420, 520, 720, 920 to the various components of the system 100.

The systems, methods, processes, devices, components, functionality, and features described in the present disclosure can be modified, adapted, and/or otherwise configured to be utilized with and support existing technologies and systems, future technologies and systems, or a combination thereof. In certain embodiments, the systems, methods, processes, devices, components, functionality, and features described in the present disclosure can be incorporated into and/or adapted to operate with state-of-the art or equivalent technologies that are in the process of being developed, will be developed in the future, or a combination thereof.

In certain embodiments, any device in the system 100 may transmit a signal to a memory device to cause the memory device to only dedicate a selected amount of memory resources to the various operations of the system 100. In certain embodiments, the system 100 and methods may also include transmitting signals to processors and memories to only perform the operative functions of the system 100 and methods at time periods when usage of processing resources and/or memory resources in the system 100 is at a selected value. In certain embodiments, the system 100 and methods may include transmitting signals to the memory devices utilized in the system 100, which indicate which specific sections of the memory should be utilized to store any of the data utilized or generated by the system 100. Notably, the signals transmitted to the processors and memories may be utilized to optimize the usage of computing resources while executing the operations conducted by the system 100. As a result, such functionality provides substantial operational efficiencies and improvements over existing technologies.

Referring now also to FIG. 18, at least a portion of the methodologies and techniques described with respect to the exemplary embodiments of the system 100 can incorporate a machine, such as, but not limited to, computer system 1800, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100. As another example, the computer system 1800 may assist with establishing settings relating to the wearable locator devices, transmitting signals to the wearable locator devices to cause the wearable locator devices to perform actions (e.g., activate the light emitting diodes, haptic devices, and/or other components to facilitate guiding of a user back to a leader device), receive data and/or information from the wearable locator devices (e.g., location data, notifications, battery power levels, movement data, acceleration data, sensor data, and/or any other data from the wearable locator devices), any other operation of the present disclosure, or a combination thereof.

In certain embodiments, the machine may operate as a standalone device. In some embodiments, the machine may be connected (e.g., using communications network 135, another network, or a combination thereof) to and assist with operations performed by other machines and systems, such as, but not limited to, the first user device 102, the second user device 111, wearable locator devices 120, 125, 220, 320, 420, 520, 720, 920, the server 140, the server 145, the server 150, the database 155, the server 160, any other system, program, and/or device, or any combination thereof. The machine may be connected with any component in the system 100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 1800 may include a processor 1802 (e.g., a central processing unit (CPU), a graphics processing unit (GPU, or both), a main memory 1804 and a static memory 1806, which communicate with each other via a bus 1808. The computer system 1800 may further include a video display unit 1810, which may be, but is not limited to, a liquid crystal display (LCD), a flat panel, a solid state display, or a cathode ray tube (CRT). The computer system 1800 may include an input device 1812, such as, but not limited to, a keyboard, a cursor control device 1814, such as, but not limited to, a mouse, a disk drive unit 1816, a signal generation device 1818, such as, but not limited to, a speaker or remote control, and a network interface device 1820.

In certain embodiments, the disk drive unit 1816 may include a machine-readable medium 1822 on which is stored one or more sets of instructions 1824, such as, but not limited to, software embodying any one or more of the methodologies or functions described herein, including those methods illustrated above. The instructions 1824 may also reside, completely or at least partially, within the main memory 1804, the static memory 1806, or within the processor 1802, or a combination thereof, during execution thereof by the computer system 1800. In certain embodiments, the main memory 1804 and the processor 1802 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 1822 containing instructions 1824 so that a device connected to the communications network 135, another network, or a combination thereof, can send or receive voice, video or data, and communicate over the communications network 135, another network, or a combination thereof, using the instructions. The instructions 1824 may further be transmitted or received over the communications network 135, another network, or a combination thereof, via the network interface device 1820.

While the machine-readable medium 1822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. In certain embodiments, the “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure is not limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

We claim:

1. A wearable device, comprising:
a geolocator device configured to:
pair with at least one other wearable device;
establish a threshold distance from the wearable device for triggering transmission of a signal to the at least one other wearable device for guiding the at least one other wearable device; and
transmit, upon detection that the at least one other wearable device is at or beyond the threshold distance from the wearable device, the signal to the at least one other wearable device to cause the at least one other wearable device to generate an output to facilitate guiding of the at least one other wearable device back within the threshold distance from the wearable device.

2. The device of claim 1, further comprising a display interface comprising at least one light emitting diode configured to provide the output in response to the signal, wherein the output comprises a light pattern emitted by the at least one light emitting diode to guide the at least one other wearable device within the threshold distance from the wearable device.

3. The device of claim 1, further comprising a haptic device configured to provide the output in response to the signal, wherein the output comprises a pattern of vibrations generated by the haptic device to guide the at least one other wearable device back within the threshold distance from the wearable device.

4. The device of claim 1, further comprising a casing enclosing the geolocator device and comprising a band configured to be worn by a user, wherein the casing comprises a waterproof material comprising at least one of silicone, titanium, stainless steel, leather, plastic, latex, water-proof coated materials, ceramic, or carbon fiber.

5. The device of claim 1, further comprising an input device, wherein the input device is configured to establish the wearable device as a leader device of a group of wearable devices comprising the wearable device and the at least one other wearable device based on a first type of interaction with the input device.

6. The device of claim 5, wherein the input device is configured to initiate pairing with the at least one other wearable device based on a second type of interaction with the input device.

7. The device of claim 6, wherein the input device is configured to enable a locate mode, activate a display of the wearable device, or a combination thereof, based on a third type of interaction with the input device.

8. The device of claim 7, wherein the input device is configured to activate or deactivate the wearable device based on a fourth type of interaction with the input device.

9. The device of claim 1, wherein the wearable device further comprises a wireless charging component configured to wirelessly charge a battery of the wearable device when connected to a charger connected to a power source.

10. The device of claim 1, wherein the geolocator device further comprises a processor, a memory, a location sensor, a communication device, or a combination thereof.

11. The device of claim 1, wherein the wearable device further comprises an adjustable bracelet or strap to enable the wearable device to be worn by a user.

12. A system, comprising:
a first wearable device; and
at least one second wearable device, wherein the at least one second wearable device is configured to:
pair with the first wearable device;
establish a threshold distance from the first wearable device for triggering transmission of a signal from the first wearable device to guide the at least second wearable device to the first wearable device;
receive, after detection that the at least second wearable device is at or beyond the threshold distance from the first wearable device, the signal from the first wearable device; and
generate, in response to the signal, an output to facilitate guiding of the at least one second wearable device back within the threshold distance from the first wearable device.

13. The system of claim 12, wherein the output comprises display of a plurality of colors of light via at least one light emitting diode in a display interface of the at least one second wearable device, wherein a first color of the plurality of colors of light is lit on a portion of the display interface to indicate a first direction to guide the at least one second wearable device to the first wearable device, and wherein at least one second color of the plurality of colors of light are lit on a remaining portion of the display to indicate a wrong direction.

14. The system of claim 13, wherein the output comprises a pattern of haptic vibrations that adjust in frequency, duration, or a combination thereof, to indicate a direction to guide the at least one second wearable device to the first wearable device.

15. The system of claim 12, wherein the output comprises display of a color of light via at least one light emitting diode in a portion of a display interface of the at least one second wearable device to indicate a direction to guide the at least one second wearable device to the first wearable device, and not outputting display of at least one other light emitting diode in a remaining portion of the display interface.

16. The system of claim 12, wherein the at least one second wearable device is further configured to transmit a notification to a mobile device in communication with the at least one second wearable device, the first wearable device, or a combination thereof, to indicate that the at least one second wearable device is at or beyond the threshold distance.

17. The system of claim 12, wherein the at least one second wearable device comprises a slit in a top surface of a material covering at least one light emitting diode of the at least one second wearable device, and wherein the output comprises light emitted by the at least one light emitting diode to indicate a direction to guide the at least one second wearable device to the first wearable device and which is visible to a user via the slit.

18. The system of claim 12, wherein the at least one second wearable device is configured to stop the output when the at least one second wearable device is within the threshold distance from the first wearable device.

19. A method, comprising:
pairing a first wearable device with at least one second wearable device;
establishing a threshold distance from the first wearable device for triggering transmission of a signal from the first wearable device to guide the at least second wearable device to the first wearable device;
receiving, at the at least one second wearable device and after detection that the at least second wearable device is at or beyond the threshold distance from the first wearable device, the signal from the first wearable device; and
generating, in response to the signal, an output to facilitate guiding of the at least one second wearable device back within the threshold distance from the first wearable device.

20. The method of claim 19, further comprising generating the output by outputting light, vibrations, sounds, or a combination thereof, on the at least one second wearable device.
